(19) United States
(12) Patent Application Publication
(10) Pub. No.: US 2007/0186250 A1
(43) Pub. Date: Aug. 9, 2007

(54) Video processing methods and systems for portable electronic devices lacking native video support

(75) Inventor: Richard Scott Carey, Toronto (CA)

Correspondence Address: JLB CONSULTING, INC.;c/o INTELLEVATE, P.O. BOX 52050, MINNEAPOLIS, MN, 55402, US

(73) Assignee: Sona Innovations Inc.

(21) Appl. No.: 11/701,221

(22) Filed: Feb. 1, 2007

Related U.S. Application Data
(60) Provisional application No. 60/764,999, filed on Feb. 3, 2006.

(51) Int. Cl. H04N 7/173; H04N 7/16

(52) U.S. Cl. 725/62; 725/100; 725/90

(57) ABSTRACT

Methods and systems for providing high-quality, synchronized audio/video playback on Blackberry™-type portable electronic devices lacking native video support. Synchronization intervals are determined whereby to instantiate frame rate control signals for processing and synchronizing data in the form of stored images and audio to generate the synchronized audio/video playback.

### CROSS-REFERENCE TO RELATED APPLICATIONS

This application claims the benefit of U.S. provisional application Ser. No. 60/764,999 filed Feb. 3, 2006, by Carey, Richard Scott, titled VIDEO PROCESSING METHODS AND SYSTEMS FOR PORTABLE ELECTRONIC DEVICES LACKING NATIVE VIDEO SUPPORT.

### FIELD OF THE INVENTION

The present invention relates generally to video processing and more particularly to methods and systems for rendering video on portable devices lacking conventional video playback support.

### BACKGROUND OF THE INVENTION

The use of mobile devices such as smart phones, pocket personal computers, personal digital assistants and the like has become wide-spread. Such devices provide mobile phone support, portable computing support and, as supporting networks provide increased bandwidth capability, the devices can further provide media communication and rendering. It is not unusual for different service providers to make available streaming audio and video in formats typically compatible with mobile devices.

As is known in the art, the BlackBerry™ is a wireless handheld device that was first introduced in 1999. It supports e-mail, mobile telephone, text messaging, web browsing and other wireless information services. It is provided by Research In Motion through cellular telephone companies.

One limitation of the BlackBerry™ and similar devices is that they either lack standard video/audio decoding systems or provide limited implementations of such systems that cannot be used to provide acceptable quality synchronized video and audio in a performance constrained device, such as the Blackberry and/or similarly functional devices with the following characteristics:

J2ME. J2ME (Java2 Micro Edition) is a small footprint, low performance run-time interpreted variation of the Java language. As the sole embedded runtime language in many mobile devices, it provides the only API access to device system functionality for 3rd party, after market software developers. As an interpreted run-time language, the current versions of J2ME as they exist today are not intended for—or capable of—achieving software-only audio/video decoding at an acceptable level of performance.

Device processing capabilities. Most J2ME mobile devices (such as the Blackberry devices) have low cost, low power, and thus—low clock speed CPUs. Ideal for the intended basic communication role of these devices, this limitation is a hindrance to software-based decoding.

Many mobile devices, such as Blackberry™ devices as they exist today have no integrated video decoding systems (either special dedicated auxiliary hardware sub-systems, or as embedded native code firmware decoders).

An audio system that does not expose the meta-data necessary to provide time-based synchronization.

No solution known to the inventor provides for audio synchronized streaming video playback with optimal motion rendering on this class of handheld wireless devices. This places this class of portable electronic devices at a considerable disadvantage to competitive devices such as typical, current generation cellular telephones, which enable high-quality, streaming, synchronized audio/video for users.

### SUMMARY OF THE INVENTION

The present invention provides video/audio media encoding, decoding, and playback rendering methods and systems for Blackberry™ and other devices not equipped with platform video playback support.

In a broader sense the invention provides methods and systems for providing synchronized video and audio media playback on J2ME (Java 2 Mobile Edition) MIDP (Mobile Information Device Portfolio) devices that do not have embedded native video decoding and do not provide fully implemented JSR 135 (Java Specification Request 135) methods for retrieving audio playback status meta-data or do not provide JSR 135 compliant access to embedded sampled audio decoding capabilities.

In one embodiment of the invention there are provided methods and systems for playing synchronized audio and video on a mobile communication device including a video screen and a speaker, a method comprising:

identifying on the device a still image decoder;

identifying for playback by the device an audio/video media file including a series of still images, an audio signal and metadata including the total number of a series of image frames and the duration of the audio/video media file;

determining for the device a synchronization interval for displaying the series of stored still images in synchronization with the playback of the stored audio signal;

displaying, based upon the synchronization interval, the series of stored still images; and

synchronizing, based on the synchronization interval, the playback of the stored audio signal with the displaying of the series of stored still images;

whereby synchronized audio and video are played back on the device.

In another embodiment of the invention there are provided methods and systems for playing synchronized audio and video on a mobile communication device including a video screen and a speaker and lacking a native video decoding function, a method comprising:

identifying on the device a still image decoder;

identifying on the device an audio/video media file including a series of still images and an audio signal;

the audio/video media file based upon a processed media format and including therewith metadata identifying the total number of a series of image frames and the duration of the media file;

determining for the device a synchronization interval for displaying the series of still images in synchronization with the playback of the stored audio signal, the synchronization interval based upon one of the group comprising a initial synchronization interval based upon a rendering and an initial synchronization interval based upon an ideal frame-per-second playback rate;

playing back the audio signal;

displaying in synchronization with the playing back of the audio signal, using a sleep interval based upon the synchronization interval, the series of still images; and

periodically adjusting the sleep cycle based upon a calculated number of frames played and an actual number of frames played whereby to keep the displaying of the series of still images in synchronization with the playing back of the audio signal;

whereby synchronized audio and video are played back on the device.

### DRAWING FIGURES

These and other objects, features and advantages of the present invention will now become apparent through a consideration of the following Detailed Description Of The Invention considered in conjunction with the drawing Figures, in which:

FIG. 1 is a block diagram showing a mobile device communications system;

FIG. 2 is a block diagram showing the process steps and functional components for synchronizing the audio/video playback in accordance with a described embodiment of the invention.

### DESCRIPTION OF THE INVENTION

As described above, the present invention provides methods and systems for providing synchronized video and audio media playback on J2ME (Java 2 Mobile Edition) MIDP (Mobile Information Device Portfolio) devices that do not have embedded native video decoding and do not provide fully implemented JSR 135 (Java Specification Request 135) methods for retrieving audio playback status meta-data or do not provide JSR 135 compliant access to embedded sampled audio decoding capabilities. A unique aspect of the present invention is the way in which it overcomes the performance constraints of the Blackberry and similar device's interpreted J2ME (Java 2 Mobile Edition) based operating system and APIs (application programming interfaces), which do not provide adequate performance characteristics to allow for the creation of a software implementation of modern standard video codecs (compression/decompression, or coder-decoder).

As used herein examples and illustrations are exemplary and not limiting.

While the invention is generally illustrated with respect to a BlackBerry™ mobile device, it is not thus limited. The reader will understand that the invention is equally applicable to all mobile devices possessing the described characteristics that result in an inability to render synchronized audio/video in the absence of the present invention.

As described in detail below, the present invention provides methods and systems for achieving acceptable audio/video playback and synchronization by utilizing the methods and systems described below.

A process is provided which references a sequence of JPEG (Joint Photographic Experts Group) (alternatively PNG (Portable Network Graphics) in systems that do not support JPEG decoding natively) encoded images that are stored on the device and utilize the Blackberry™'s embedded JPEG still image decoder (the only suitable image related encoding system that is embedded natively) to decode each referenced image, thus providing a variant of motion JPEG for the video portion of the A/V (audio/video) system for Blackberry. In addition to the JPEG and PNG images, basic temporal compression can be employed to compress the video and provide the series of still image image frames, which can integrate with the proposed system in a manner identical to full image motion, using a predictive image frame method whereby the series of images can comprise both full images and partial images that contain only the relevant motion changed image data for a given predictive frame. The entire sequence can be stored on the device, up to the amount of available device storage, or the images can exist in a runtime memory buffer if the system is used to ‘stream’ images via the devices network connection. It will be understood by the reader that on the described Blackberry™ devices, a native jpg decoder is embedded and is exposed as part of the unique RIM (Research In Motion) Java extensions. On other J2ME compliant devices, we can assume that PNG format compression is available, as although JPG is considered an optional standard for J2ME compliance, PNG is a requirement. In such a device environment (that meets all of the other device constraints and characteristics outlined here), PNG can be utilized.

Existing encoder libraries and/or applications are used to transcode video/audio media files from an existing media format, to the sequential JPG image files used for the outlined media system. As noted above, these images can be stored on the mobile device and/or streamed into a runtime memory buffer from a network connection.

J2ME MMAPI (Multimedia Java API) (JSR 135) interface is used for playback of audio in one of the following formats: MPEG (Moving Pictures Expert Group) Layer-3, AMR (Adaptive Multi-Rate), or ADPCM (Adaptive Pulse Code Modulation). MMAPI (JSR 135) is a standardized, optional API for J2ME that is implemented on various mobile devices, and covers audio and video capabilities. On the Blackberry, for example, the MMAPI is limited to audio only. Further, despite it being a compliance requirement for JSR 135, all Blackberry™ devices that implement JSR 135 for sampled audio (up to the 8700 series Blackberry™ devices) do not correctly implement the standard JSR methods to expose the audio meta-data that could normally be utilized to enable acceptably accurate synchronization of audio to video frame rendering in such a scenario.

On Blackberry™ models that predate inclusion of JSR-135 support for sampled audio, but still include sampled audio capabilities (this includes Blackberry™ 7100 series models) and other similar devices, the Blackberry™ audio Alert (or similar) APIs (only intended for playback of audio alerts or ‘ring-tones’) can be leveraged to provide playback of sampled audio for the video/audio system. By using the described synchronization system (below), which is based on meta-data from the defined meta-data format, audio synchronization is achieved even without available real-time access to playback status meta-data from the embedded audio system. Thus, the described solution also compensates for the lack of access to this internal Alert API data that is not exposed via the Blackberry audio Alert APIs and methods and similar capabilities on alternative devices.

A basic format for media file meta-data allows for information essential for the synchronization of audio and video in the J2ME environment. The key data for the outlined system includes:

Total number of images/video frames

Duration (in milliseconds) of the media to play

### Typically, additional, standard media descriptive information would also be included with data as well (title, author, date, category, media type, rating, etc.) but is not essential to the system.

The actual system for synchronization of sampled audio playback to rendered video frames is implemented as J2ME byte code. This is explained in detail below.

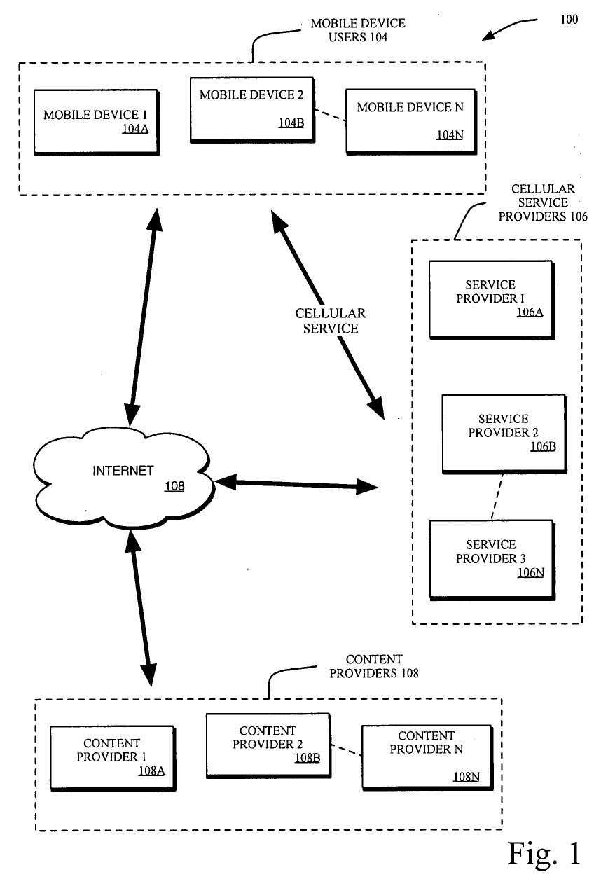

FIG. 1 shows a conventional system 100 including a plurality of mobile devices 104A-104N, a plurality of mobile service providers 106A-106N and a plurality of content providers 108A-N. Mobile devices 104 include those such as the BlackBerry™ and similar devices having the functionalities, capabilities and limitations as described herein. Mobile service providers 106 include well-known service providers such as cellular providers Verizon™, Cingular™, Sprint™ and others as are well known to the reader. Content providers 108 include well known Internet content providers, for example amazon.com, google.com, yahoo.com and others as are well known to the reader. In operation, the mobile devices 104 receive telephone service, email service, messaging service, content and other conventional mobile device services and information through the mobile service providers 106 via cellular communications and/or through an electronic network such as through a WiFi connection to Internet 108 directly from service and/or content providers.

While the invention is shown and described with respect to mobile devices, it will be understood by the reader that the invention is equally applicable when such devices are connected through a wire-connection to receive the appropriate content, for example to a personal computer or other source of content, and also to similarly functional devices which otherwise have different or no wireless capability.

In accordance with the present invention, at least a portion of the content may include the processed audio/video content to be played on the device, the processed audio/video content including the image frames, audio file and metadata as provided herein above. Such processed audio/video content may be provided, for example, by a content provider, a service provider, or another able to communicate data onto the mobile devices.

### Details of Audio Video Synchronization:

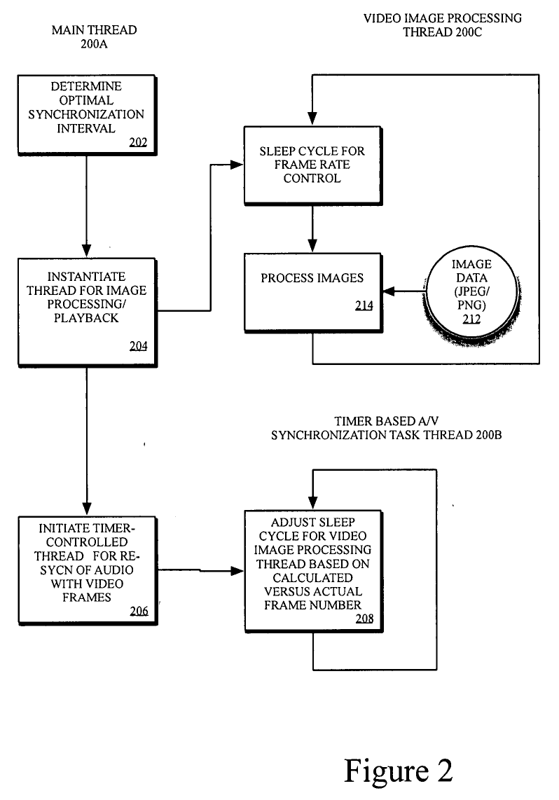

To provide audio/video synchronization, a timer-based synchronization task thread 200B runs at preset intervals as shown in FIG. 2. The various processes and functions supporting this synchronization will now be described.

With reference to FIG. 2 and particularly to the Main Processing Thread 200A, an optimal timer interval for the synchronization task is related to the processing capabilities of a particular device (e.g. Blackberry model), as different devices run at different CPU processor clock speeds and with different CPU types and system architectures. An optimal interval is determined by the execution of an embedded benchmark task (202) which, at application startup, performs ‘invisible’ rendering of X number of frames (where X is a preset number considered to be of adequate sample size) to determine a FPS (frames per second) approximation for the particular device, using the following standard sub-algorithm:

Given X number of benchmark frames:

FPS(frames per second)=X/(task completion time−task start time)

In one embodiment of the invention, the determined optimal interval is an initial optimal sleep interval for the video processing thread used by the synchronization task as a starting value and is adjusted in subsequent executions of the synchronization task.

In another embodiment of the invention, the initial interval value is based solely on the encoded FPS of the media file (i.e. the ideal FPS), with the assumption that any discrepancy between this encoded FPS and the actual performance (processing capabilities) of the device, will be compensated for when the interval is adjusted by the feedback of the system described herein below. This method has an advantage of being simpler to implement although it makes the additional assumption that the (approximate) device capabilities are targeted during the media encoding process.

Regardless of which of the above-described methods is employed to determine the FPS, with the FPS (frames per second) determined, a simple calculation yields the initial synchronization interval in milliseconds:

Interval=1000/FPS

Determination of FPS at application initialization is key to several points of optimization within the outlined system of synchronization:
Determining optimal a/v synch (audio/video synchronization) task interval, including determining an optimal duration of the sleep cycle used by the frame processing thread, as calculated by the A/V synch (audio/video synchronization) task, if required, that is if the calculated current frame index is less than actual current frame index as described below.
Determining optimal frame skip for playback of video frames (standard media playback technique) on said device, including determining optimal frame skip for playback of video frames on the device if the calculated current frame index is greater than actual current frame index as described below.

Once the optimal interval timing offset is determined, the system instantiates a timer controlled thread which itself executes at a preset interval cycle (204), for example once for every interval cycle. This thread task provides re-synchronization of audio with video frames (206) using a basic algorithm with parameters based upon media frame and duration information, captured during the media encoding process and presented as proprietary formatted media meta-data file.

High-level of A/V sync task algorithm:

current frame=(total frames/(media duration/(current system time−system time at start of media playback)))

Key to further increasing the accuracy of media synchronization is to compare the current frame number to that of the sync tasks calculated frame number. With respect to FIG. 2, the Timer Based A/V Synchronization Task Thread 200B, the sync task adjusts the current frame number to synchronize with the current media time and stores the difference between actual and calculated frame index numbers for the given sync task execution cycle, for use in the next iteration. Multiple executions of the sync task yields an average differential that is used to adjust the sleep cycle within the frame processing thread (208). This average is used (instead of simply using the value of the difference between the last calculated frame index and the last actual current frame index) in order to provide mitigation against overcompensation based on temporary system background activity (system thread activity, other 3rd party application activity, java garbage collection, etc.). This adaptive feedback system provides for reasonably accurate A/V synchronization without noticeable ‘frame jumping’ which has a negative impact on user perception of quality.

Continuing with reference to FIG. 2 and particularly to Video Image Processing Thread 200C, the adjusted sleep cycle for frame rate control (210) is used to process images image data (212) whereby the images are processed to provide the images (214) which are synchronized with the audio (step 206) for playback on the handheld device.

It will thus be understood that, in the described embodiment of the invention, the processes and functions of the invention are preferably implemented in software using the limited image display and audio playback capabilities of the portable device.

There are thus provided methods and systems for providing high-quality, synchronized audio/video playback on Blackberry™-type portable electronic devices lacking native video support. The invention has significant commercial value in enabling the provision of this significant feature to device users, increasing the device's competitiveness in the industry.

While the invention has been shown and described with respect to particular embodiments, it is not thus limited. Numerous modifications, changes and enhancements will now be apparent to the reader.

What is claimed is:

1. A method for playing synchronized audio and video on a mobile communication device including a video screen and a speaker, comprising:
identifying on the device a still image decoder;
identifying for playback by the device an audio/video media file including a series of still images, an audio signal and metadata including the total number of a series of image frames and the duration of the audio/video media file;
determining for the device a synchronization interval for displaying the series of stored still images in synchronization with the playback of the stored audio signal;
displaying, based upon the synchronization interval, the series of stored still images; and
synchronizing, based on the synchronization interval, the playback of the stored audio signal with the displaying of the series of stored still images;
whereby synchronized audio and video are played back on the device.

2. The method of claim 1 wherein the step of displaying the series of stored still images includes the steps of:
determining, based on the synchronization interval, a sleep cycle for frame rate control; and
the displaying based upon the sleep cycle.

3. The method of claim 2 wherein the step of identifying for the device a synchronization interval includes determining an initial synchronization interval.

4. The method of claim 3 wherein the determining of an initial synchronization interval is performed by processing an invisible rendering of a pre-determined number of the series of stored still images.

5. The method of claim 3 wherein the determining of an initial synchronization interval is based upon an ideal frame-per-second playback rate based upon the series of stored still images.

6. The method of claim 2 and further comprising the step of periodically adjusting the sleep cycle based upon a calculated number of frames played and an actual number of frames played.

7. The method of claim 1 wherein the series of still images and the audio signal are generated from a processed media format.

8. The method of claim 1 wherein the step of synchronizing the playback of the stored audio signal with the displaying of the series of stored still images is based on the current still image being played, the total number of stored still images and the media duration.

9. The method of claim 1 wherein the device comprises a Java 2 Mobile Edition Mobile Information Device Portfolio device lacking embedded native video decoding.

10. The method of claim 1 wherein the series of still images each comprise a format selected from the group comprising a JPEG image, a PNG image and a compressed video image.

11. The method of claim 1 wherein each image in the series of image frames is selected from the group comprising a single still image and multiple component images.

12. A method for playing synchronized audio and video on a mobile communication device including a video screen and a speaker and lacking a native video decoding function, comprising the steps of:
identifying on the device a still image decoder;
identifying on the device an audio/video media file including a series of still images and an audio signal;
the audio/video media file based upon a processed media format and including therewith metadata identifying the total number of a series of image frames and the duration of the media file;
determining for the device a synchronization interval for displaying the series of still images in synchronization with the playback of the stored audio signal, the synchronization interval based upon one of the group comprising a initial synchronization interval based upon a rendering and an initial synchronization interval based upon an ideal frame-per-second playback rate;
playing back the audio signal;
displaying in synchronization with the playing back of the audio signal, using a sleep interval based upon the synchronization interval, the series of still images; and
periodically adjusting the sleep cycle based upon a calculated number of frames played and an actual number of frames played whereby to keep the displaying of the series of still images in synchronization with the playing back of the audio signal;
whereby synchronized audio and video are played back on the device.

13. A system for playing synchronized audio and video on a mobile communication device including a video screen and a speaker, comprising:
a processor;
a memory connected to the processor and storing instructions for controlling the operation of the processor and at least a portion of an audio/video media file including a series of still images, an audio signal and metadata including the total number of a series of image frames and the duration of the audio/video media file;
a still image decoder connected to the processor;
an audio player connected to the processor;
the processor operative with the instructions to perform the steps of:
identifying for playback by the device the audio/video media file;
determining for the device a synchronization interval for displaying the series of stored still images in synchronization with the playback of the stored audio signal;
displaying using the still image decoder, based upon the synchronization interval, the series of stored still images; and
synchronizing, based on the synchronization interval, the playback through the audio player of the stored audio signal with the displaying of the series of stored still images;
whereby synchronized audio and video are played back on the device.

14. The system of claim 13 wherein the step of displaying the series of stored still images includes the steps of:
determining, based on the synchronization interval, a sleep cycle for frame rate control; and
the displaying based upon the sleep cycle.

15. The system of claim 14 wherein the step of identifying for the device a synchronization interval includes determining an initial synchronization interval.

16. The system of claim 15 wherein the determining of an initial synchronization interval is performed by processing an invisible rendering of a pre-determined number of the series of stored still images.

17. The system of claim 15 wherein the determining of an initial synchronization interval is based upon an ideal frame-per-second playback rate based upon the series of stored still images.

18. The system of claim 14 and further comprising the step of periodically adjusting the sleep cycle based upon a calculated number of frames played and an actual number of frames played.

19. The system of claim 13 wherein the series of still images and the audio signal are generated from a processed media format.

20. The system of claim 13 wherein the step of synchronizing the playback of the stored audio signal with the displaying of the series of stored still images is based on the current still image being played, the total number of stored still images and the media duration.

21. The system of claim 13 wherein the device comprises a Java 2 Mobile Edition Mobile Information Device Portfolio device lacking embedded native video decoding.

22. The system of claim 13 wherein the series of still images each comprise a format selected from the group comprising a JPEG image, a PNG image and a compressed video image.

23. The system of claim 13 wherein the series of image frames comprises one of the group of still images and component images.

24. A system for playing synchronized audio and video on a mobile communication device including a video screen and a speaker, comprising:
means for identifying on the device a still image decoder;
means for identifying for playback by the device an audio/video media file including a series of still images, an audio signal and metadata including the total number of a series of image frames and the duration of the audio/video media file;
means for determining for the device a synchronization interval for displaying the series of stored still images in synchronization with the playback of the stored audio signal;
means for displaying, based upon the synchronization interval, the series of stored still images; and
means for synchronizing, based on the synchronization interval, the playback of the stored audio signal with the displaying of the series of stored still images;
whereby synchronized audio and video are played back on the device.
